(19) United States
(12) Patent Application Publication
(10) Pub. No.: US 2026/0122031 A1
(43) Pub. Date: Apr. 30, 2026

(54) INTERNET PROTOCOL (IP) ADDRESS SHARING AND SYSTEM RECOVERY

(71) Applicant: Cisco Technology, Inc., San Jose, CA (US)

(72) Inventor: Binod Roay, Fremont, CA (US)

(21) Appl. No.: 18/934,066

(22) Filed: Oct. 31, 2024

(51) Int. Cl. H04L 61/5053; H04L 61/5007

(52) U.S. Cl. CPC H04L 61/5053; H04L 61/5007

(57) ABSTRACT

This disclosure describes techniques for a system to share an IP address between computing resources (e.g., between a host server and its management controller), such that a server system may be recovered in the event of a system failure. For example, the host server may send a message to its management controller, such as a baseboard management controller, indicating that the IP address provided to the server system is in use, where the message may be sent at particular time intervals and/or within a threshold period of time. When a failure occurs with respect to the server system, the host server may be unable to send the message at the particular time interval and/or within the threshold period of time. Accordingly, the management controller may be configured to receive, or otherwise recover, the IP address such that the entire server system is accessible and recoverable.

### TECHNICAL FIELD

The present disclosure relates generally to the field of computer networking, and more particularly, IP address sharing for remote system recovery.

### BACKGROUND

Computer networks are generally a group of computers or other devices that are communicatively connected and use one or more communication protocols to exchange data. For instance, computer networking can refer to connected computing devices (such as laptops, desktops, servers, smartphones, and tablets) as well as an ever-expanding array of Internet-of-Things (IoT) devices (such as cameras, door locks, doorbells, refrigerators, audio/visual systems, thermostats, and various sensors) that communicate with one another. Modern-day networks deliver various types of network architectures, such as Local-Area Networks (LANs) that are in one physical location such as a building, Wide-Area Networks (WANs) that extend over a large geographic area to connect devices associated with individual users or LANs, Enterprise Networks that are built for a large organization, Internet Service Provider (ISP) Networks that operate WANs to provide connectivity to devices associated with individual users or enterprises, software-defined networks (SDNs), wireless networks, core networks, cloud networks, and so forth.

As part of such computer networks, in typical data center deployment, virtual machines (VM(s)) may be located in one or more servers, where the one or more servers may be located in server racks of the data center. However, companies, government agencies, universities, and/or other entities (hereinafter “enterprises”) may use virtualization platforms and/or digital network architectures at one or more branch offices of an enterprise. For example, virtualized network functions (e.g., routing, firewalls, switching, etc.) may be deployed at the branch (hereinafter “vBranch”) as VMs for centralized management and device consolidation. The server systems associated with a vBranch are typically associated with a single device, and when such server systems are provided with an Internet Protocol (IP) address, only one IP address is available to be assigned to the server system. Additionally, a server system of a vBranch may include a management controller that is configured to enable remote access of the server system. However, when an error occurs with respect to the system (e.g., a failure of the host server), the system cannot be recovered remotely due to the loss of the single IP address, as the management controller will no longer be able to provide remote management and server system access. Instead, the server system must be physically connected to in order to be recovered (e.g., via a recovery console).

Accordingly, a need exists for systems and methods enabling a mechanism such that at IP address can be shared in a server system between a management controller and server operating system in the event of a server failure.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example environment for the exchanging of messages between computing resources for IP address sharing.

FIG. 2 illustrates an example environment for IP address sharing using virtual machine (VM) instances associated with a host server.

FIG. 3 illustrates an example environment for IP address sharing for both Dynamic Host Configuration Protocol (DHCP) and statically-configured interfaces.

FIG. 4 illustrates a flow diagram of an example method for IP address sharing.

FIG. 5 illustrates a computing system diagram illustrating a configuration for a data center that can be utilized to implement aspects of the technologies disclosed herein.

FIG. 6 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

This disclosure describes techniques for the sharing of an Internet Protocol (IP) address between computing resources (e.g., the management controller and host server) such that the server system may be recovered in the event of a system failure, such as in vBranch environments.

A method to perform the techniques described herein includes allocating an IP address to a first computing resource (e.g., host server and/or host server components) and receiving, at a second computing resource (e.g., the management controller of the host server) and from the first computing resource, a first message indicating that the IP address is in use. The method may further include determining a threshold period of time for receiving a second message indicating that the IP address is in use, and determining whether the second message has been received within the threshold period of time. The method may include, based at least in part on determining that the second message has not been received within the threshold period of time, obtaining, by the second computing resource, the IP address. Additionally, or alternatively, the method may include, based at least in part on determining that the second message has been received within the threshold period of time, refraining from obtaining, by the second computing resource, the IP address.

Additionally, the techniques described herein may be performed by a system and/or device having non-transitory computer-readable media storing computer-executable instructions that, when executed by one or more processors, performs the method described above.

### Example Embodiments

Various implementations of the present disclosure provide techniques for the sharing of an IP address between computing resources such that the server system may be recovered in the event of a system failure, such as in vBranch environments. As discussed above, an enterprise may use virtualization platforms and/or digital network architectures at one or more branch offices of the enterprise. For example, virtualized network functions (e.g., routing, firewalls, switching, etc.) may be deployed at the vBranch as VMs for centralized management and device consolidation. The server systems associated with a vBranch are typically associated with a single device, and when such server systems are provided with an IP address, only one IP address is assigned to the server system. Additionally, a server system of a vBranch may include a management controller that may enable remote access of the server system. However, when an error occurs with respect to the system (e.g., a failure of the host server), the system cannot be recovered remotely due to the loss of the single IP address, as the management controller may no longer be able to provide remote management and access to the server. Instead, the server must be physically connected to in order to be recovered (e.g., via a recovery console).

Accordingly, a need exists for systems and methods enabling a mechanism such that at IP address can be shared between a management controller and server operating system in the event of a server failure.

This disclosure describes techniques and mechanisms for a system to share an IP address between computing resources (e.g., between a host server and its management controller), such that the server system may be recovered in the event of a system failure. In some examples, the system, such as a server system, may be associated with one or more components (e.g., processor, operating system, etc.) of the host server (hereinafter collectively referred to as “server”) and its management controller, such as a baseboard management controller (BMC). The management controller may be included in the server, but may operate independently from the server. In some instances, when the server is initiated, or powered on, an IP address may be obtained by the associated management controller. The server, and/or one or more components of the server (e.g., processor, operating system, etc.), may be configured to communicate with its management controller such that the IP address is released by the management controller and may be used by the server. Additionally, or alternatively, once the server has received the IP address, the server may be configured to further communicate, and/or send a message to, the management controller, where the message may indicate that the IP address is in use by the server and/or the one or more components of the server. In some examples, the sending of the message indicating that the IP address is in use may be associated with a threshold period of time and/or time intervals for receipt by the management controller. For example, the server may be configured to send a message every two minutes. In some instances, such as in the event of a failure associated with the server system, the server may be unable to send the message within the threshold period of time and/or at the time interval associated with the message (e.g., the message is not received by the management controller at the four-minute mark). Accordingly, the management controller may be configured to receive, or otherwise recover, the IP address such that the server system is recoverable.

In some examples, the server system may comprise a server that may be associated with, or installed in, a network environment. In some instances, the server may be associated with a management controller that may be configured to remotely provide server management (e.g., across enterprise branch locations). For example, the management controller may be configured to manage and/or monitor the state of the server system independently of any associated processors or the server operating system. In some instances, the management controller may be configured to provide server management and/or monitoring remotely via an Intelligent Platform Management Interface (IPMI) running on the management controller. Additionally, or alternatively, the management controller may be accessed by a shared LAN On Motherboard (LOM) Ethernet port, where the shared LOM Ethernet port may be configured to provide an IP address to the entire server system. Additionally, or alternatively, the server system may not include a shared LOM Ethernet port for both the server and the management controller, but instead a dedicated management port to access the management controller. Additionally, or alternatively, the management controller and the server may each be associated with a different physical port.

In some instances, the server system may be configured to receive an IP address from a Dynamic Host Configuration Protocol (DHCP) server. For example, the server system may receive the IP address from the DHCP server via the shared LOM Ethernet port connected to a network. In some instances, the management controller may include, or work in combination with, a DHCP client to request an IP address from the DHCP server via an interface of the shared LOM Ethernet port. Additionally, or alternatively, the management controller may receive the IP address from the DHCP server via a different type of port (e.g., dedicated management port, etc.). Additionally, or alternatively, the server system may be configured to be assigned a static IP address via an interface associated with the server system.

Once the IP address has been allocated to the server system, such as to the management controller via a request by the DHCP client, the server may subsequently be started-up, booted, released from reset, etc. Additionally, or alternatively, the server may be configured to subsequently send a message to the management controller indicating that the IP address is in use, or will be in use, by the server. In some instances, the server may send the message via the IPMI. This way, the management controller may disable the DHCP client associated with the management controller and relinquish the IP address and/or disable the usage of the IP address. In some instances, once the IP address has been relinquished by the management controller, the server may receive, begin using, and/or continue using the IP address. For example, the server may receive the IP address from the DHCP server via the shared LOM Ethernet port and/or a different physical port. Accordingly, the server may subsequently use, and/or be associated with, the IP address for network communications. Additionally, or alternatively, the server may be configured to send additional messages to the management controller. The messages may include an indication that the IP address is being used by the server (i.e., an “IP alive” message) and/or an indication that the DHCP client associated with the management controller is to remain disabled. In some examples, the messages may be sent via the IPMI.

Additionally, or alternatively, the messages may be associated with a threshold period of time and/or time intervals for receipt by the management controller. For example, a message may be sent from the server to the management controller every two minutes. Additionally, or alternatively, the management controller may be configured to determine a threshold period of time at which the message is expected to be received (e.g., based on a message being sent every two minutes). When a message is received and/or sent within the threshold period of time and/or the time intervals associated with the message, it may indicate that the server (e.g., processor, operating system, etc.) is functioning normally. When a message is not received and/or sent within the threshold period of time and/or the time intervals associated the message (e.g., five minutes have passed since a message has been received by the management controller), it may indicate that a failure has occurred with respect to the server. Accordingly, the management controller may be configured to reenable its use of the IP address. For example, in instances where the IP address was obtained via a DHCP server, the management controller may be configured to restart its associated DHCP client and receive the IP address. In instances where the IP address was obtained statically, the IP address may be stored locally at the management controller, and reenabled. Additionally, or alternatively, when the message is not received and/or sent within the threshold period of time and/or the time intervals associated the message, the management controller may be configured to enable the use of the IP address at a VM instance associated with the server, as opposed to reenabling the use of the IP address at the management controller.

Once the IP address has been reenabled for use by the management controller, and/or enabled at a VM instance, the system, via the management controller, may then be accessed remotely in the event of a failure. In some instances, because the management controller has reenabled the IP address, a remote communication system may be used to access and/or connect to the system from a remote location (e.g., via an interface accessible from a graphical user interface (GUI) associated with the management controller) via a network. The remote communication system may be used to execute a troubleshoot command associated with the server system. For example, the remote communication system may be used to install an updated operating system, remediate a server failure, and/or the like.

The techniques described herein provide various improvements and efficiencies with respect to the recovery of server systems and the operation of vBranch environments. For example, when an enterprise utilizes a virtualized branch network architecture and run one or more network services as VMs, the host server systems associated with the vBranch may be reachable by a management controller. Because such server systems are typically provided with one IP address, sharing the IP address between the management controller and the host server enables the server system to still be remotely accessible via the management controller in the event of an unresponsive operating system or the server becoming offline.

Various implementations of the present disclosure will be described in detail with reference to the drawings, wherein like reference numerals present like parts and assemblies throughout the several views. Additionally, any samples set forth in this specification are not intended to be limiting and merely demonstrate some of the many possible implementations.

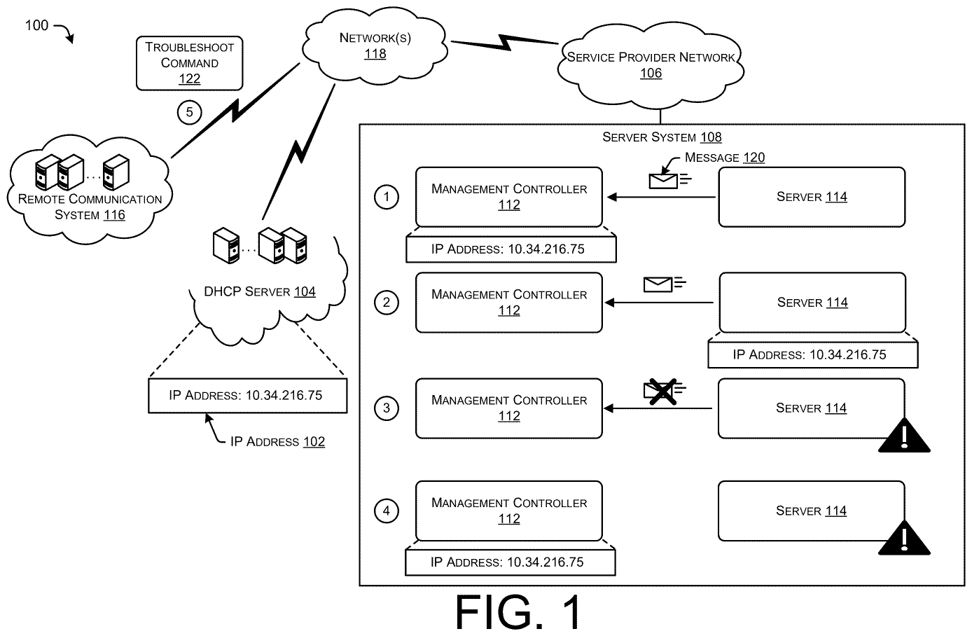

FIG. 1 illustrates an example environment 100 for the exchanging of messages 120 between computing resources for IP address 102 recovery.

In some examples, a server system 108 may comprise a host server 114 that may be associated with, or installed in, a network environment. The server system 108 may generally refer to a network-accessible system—or “cloud-based system”—implemented as a computing infrastructure of processors, storage, software, data access, and so forth that is maintained and accessible via the network(s) 118 and/or the service provider network 106. Cloud-based systems may not require end-user knowledge of the physical location and configuration of the system that delivers the services. As illustrated, the server system 108 may comprise network-accessible resource(s), such as servers and/or other devices.

In some instances, the server system 108 may be associated with a vBranch location, where the server system 108 enables the deployment of virtualized network functions. For example, the server system 108 may be associated with a vitalization platform and/or a service provider network 106. In some examples, the service provider network 106 may be or comprise a cloud provider network. A cloud provider network (sometimes referred to simply as a “cloud”) refers to a pool of network-accessible computing resources (such as compute, storage, and networking resources, applications, and services), which may be virtualized or bare-metal. The cloud can provide convenient, on-demand network access to a shared pool of configurable computing resources that can be programmatically provisioned and released in response to user commands. In other instances, however, the service provider network 106 may be an on-premises network, a private network of a corporation, and/or any other type of network or combination thereof.

In some instances, the server 114 may be associated with a management controller 112 that may be configured to remotely provide server management (e.g., across enterprise branch locations). For example, the management controller 112 may be configured to manage and/or monitor the state of the server system 108 independently of any associated processors or the server operating system. In some instances, the management controller 112 may be configured to provide server management and/or monitoring remotely via an Intelligent Platform Management Interface (IPMI) running on the management controller 112. Additionally, or alternatively, the management controller 112 may be accessed by a shared LAN On Motherboard (LOM) Ethernet port, where the shared LOM Ethernet port may be configured to provide an IP address 102 to the entire server system 108. Additionally, or alternatively, the server system 108 may not include a shared LOM Ethernet port for both the server 114 and the management controller 112, but instead a dedicated management port to access the management controller 112. Additionally, or alternatively, the management controller 112 and the server 114 may each be associated with a different physical port.

In some instances, the server system 108 may be configured to receive an IP address 102 from a Dynamic Host Configuration Protocol (DHCP) server 114. For example, the server system 108 may receive the IP address 102 from the DHCP server 104 via the shared LOM Ethernet port connected to a network, such as the service provider network and/or network(s) 118, such as the Internet. In some instances, the network(s) 118 may generally comprise one or more networks implemented by any viable communication technology, such as wired and/or wireless modalities and/or technologies. The network(s) 118 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The network(s) 118 may include devices, virtual resources, or other nodes that relay packets from one device to another.

In some instances, the management controller 112 may include, or work in combination with, a DHCP client to request an IP address 102 from the DHCP server 104 via an interface of the shared LOM Ethernet port. Additionally, or alternatively, the management controller 112 may receive the IP address 102 from the DHCP server 104 via a different type of port (e.g., dedicated management port, etc.). Additionally, or alternatively, the server system 108 may be configured to be assigned a static IP address 102 via an interface associated with the server system 108.

Once the IP address 102 has been allocated to the server system 108, such as to the management controller 112 via a request by the DHCP client, the server 114 may subsequently be started-up, booted, released from reset, etc. As illustrated, the server 114 may, at “1,” subsequently send a first message 120 to cause the management controller 112 to disable the DHCP client associated with the management controller 112 and relinquish the IP address 102. For example, the server 114 may send the message 120 via the IPMI and to the management controller 112 indicating that the IP address 102 is in use, or will be in use, by the server 114. This way, the management controller 112 may disable the DHCP client associated with the management controller 112 and relinquish the IP address 102 and/or disable the usage of the IP address. In some instances, once the IP address 102 has been relinquished by the management controller 112, the server 114 may receive, begin using, and/or continue using the IP address 102. For example, the server 114 may receive the IP address 102 from the DHCP server 104 via the shared LOM Ethernet port and/or a different physical port. Accordingly, the server 114 may subsequently use, and/or be associated with, the IP address 102 for network communications. As illustrated, the server 114 may, at “2,” continue to send message 120 to the management controller 112. The sending of the message 120 may indicate that the IP address 102 is being used by the server 114 (i.e., an “IP alive” message 120) and/or an indication that the DHCP client associated with the management controller 112 is to remain disabled. In some examples, the message 120 may be sent via the IPMI.

Additionally, or alternatively, the message 120 may be associated with a threshold period of time and/or time intervals associated with the message 120 being received by the management controller 112. As illustrated, at “3” when a message 120 is not received and/or sent within the threshold period of time and/or the time intervals associated the message 120, it may indicate that a failure has occurred with respect to the server 114. As illustrated, the management controller 112 may then, at “4,”reenable its use of the IP address 102.

Once the IP address 102 has been reenabled for use by the management controller 112, the server system 108 may then be accessed remotely in the event of a failure, such as via the management controller 112, network(s) 118, and/or the service provider network 106. In some instances, because the management controller 112 has reenabled the IP address 102, a remote communication system 116 may be used to connect to the server system 108 from a remote location. As illustrated, the remote communication system 116 may, at “5,” be used to execute a troubleshoot command 122 associated with the server system 108. For example, the remote communication system 116 may be used to install an updated operating system, remediate a server failure, and/or the like.

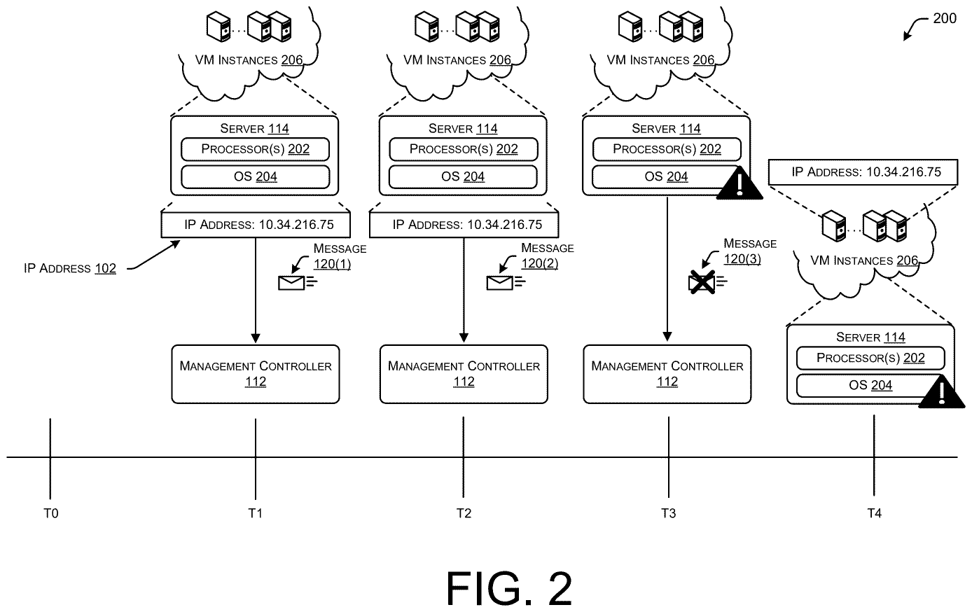

FIG. 2 illustrates an example environment 200 for IP address 102 recovery using virtual machine (VM) instances 206 associated with a host server 114. As described above, the server 114 may be associated with a management controller 112 that may be configured to remotely provide server management. Additionally, or alternatively, the server 114 may include one or more hardware processor(s) 202 (processors) configured to execute one or more stored instructions. The processors 202 may comprise one or more cores. Further, while not illustrated, server 114 may include network interfaces to allow the processor 202 or other portions of the server 114 to communicate with other devices. Network interfaces may comprise Intelligent Platform Management Interface (IPMI), Inter-Integrated Circuit (I2C), Serial Peripheral Interface bus (SPI), Universal Serial Bus (USB) as promulgated by the USB Implementers Forum, RS-232, and so forth. The server 114 may also include one or more operating systems (hereinafter “OS”) 204 utilized to control the operation of the one or more devices that comprise the service provider network 106. The OS 204 may implement a variant of the FreeBSD™ operating system as promulgated by the FreeBSD Project; other UNIX™ or UNIX-like variants; a variation of the Linux™ operating system as promulgated by Linus Torvalds; the Windows® Server operating system from Microsoft Corporation of Redmond, Washington, USA; and so forth.

As described above with respect to FIG. 1, the server 114 may be configured to send message 120 to the management controller 112. The message 120 may include an indication that the IP address 102 is being used by the server 114 (i.e., an “IP alive” message 120) and/or an indication that the DHCP client associated with the management controller 112 is to be disabled. In some examples, the message 120 may be sent via the IPMI.

Additionally, or alternatively, the message 120 may be associated with a threshold period of time and/or time intervals for receipt by the management controller 112. For example, a message 120 may be sent from the server 114 to the management controller 112 at intervals of T1, T2, T3, etc. As illustrated, message 120(1) may be sent at T1 and message 120(2) may be sent at T2, where the time between T0 and T1 may be equal to the time between T1 and T2, and so forth. As such, the management controller 112 may be configured to determine that message 120(3) is expected to be sent by the server 114 at T3, where the time between T2 and T3 is the same as the time between T1 and T2 and T0 to T1. For example, T1, T2, and T3 may each represent a two-minute interval from the previous message being sent from the server 114 to the management controller 112, where T3 represents a total of 6 minutes from T0. As illustrated, management controller 112 may be configured to expect the message 120(3) from the server at T3, however, the message 120(3) may not be received at T3 due to a failure associated with the server 114. While in such instances the management controller 112 may, at T4 (e.g., a total of 7 minutes from T0), reenable the use of the IP address 102 at the management controller 112, the management controller may also be configured to enable the use of the IP address 102 at a VM instance 206 associated with the server 114.

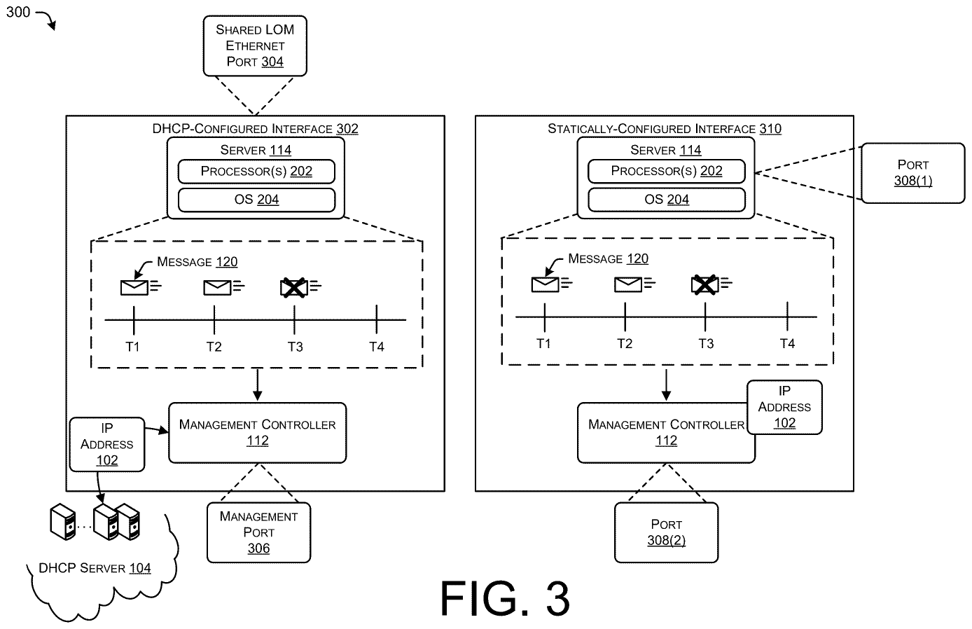

FIG. 3 illustrates an example environment 300 for IP address sharing for both DHCP-configured interfaces 302 and/or statically-configured interfaces 310. Additionally, FIG. 3 illustrates an example environment 300 for IP address sharing for different port types, such as shared LOM Ethernet port 304, dedicated management port 306, port 308(1), and/or port 308(2).

For example, a server system, such as server system 108, may be associated with a DHCP-configured interface 302, where the server system may receive an IP address 102 from the DHCP server 104. For example, the server system may receive an IP address 102 from the DHCP server 104 via the shared LOM Ethernet port 304. In some instances, the server system may be associated with a statically-configured interface 310, where the server system may be manually assigned a static IP address 102. As described above, the management controller 112 may be configured to receive a message 120 from the server 114 at specific intervals of time and/or a threshold period of time (e.g., receive message 120 at T1, T2, T3, T4, etc.). However, as illustrated, the message 120 may not be received at T3. In instances where the IP address 102 is received from the DHCP server 104, the management controller 112 may be configured to restart its associated DHCP client and receive the IP address 102 from the DHCP server 104. For example, when the message 120 is not received at T3, the management controller 112 may be configured to subsequently receive the IP address 102 from the DHCP server 104 (e.g., at T4). In instances where the IP address 102 is a static IP address and manually assigned to the server system, the IP address 102 may be stored locally at the management controller 112, and reenabled subsequent to the message 120 not being received at T3 (e.g., reenabled at T4).

Additionally, or alternatively, the management controller 112 may be accessed by a shared LOM Ethernet port 304, where the shared LOM Ethernet port 304 may be configured to provide an IP address 102 to the entire server system 108 (e.g., both the management controller 112 and the host server 114). For example, in instances where the server system is associated with a DHCP-configured interface 302, the shared LOM Ethernet port 304 may be configured to provide the IP address 102 from the DHCP server 104. Additionally, or alternatively, the server system may not include a shared LOM Ethernet port 304. Instead, the server system may include a dedicated management port 306. Additionally, or alternatively, the host server 114 may have a port 308(1) that is different from port 308(2) associated with the management controller 112. While the ports are illustrated with respect to certain interface configurations (e.g., DHCP-configured interface 302 and/or statically-configured interface 310), some ports may be used with respect to the other interface configuration.

Additionally, or alternatively, the server system 108 may not include a shared LOM Ethernet port for both the server 114 and the management controller 112, but instead a dedicated management port to access the management controller 112. Additionally, or alternatively, the management controller 112 and the server 114 may each be associated with a different physical port.

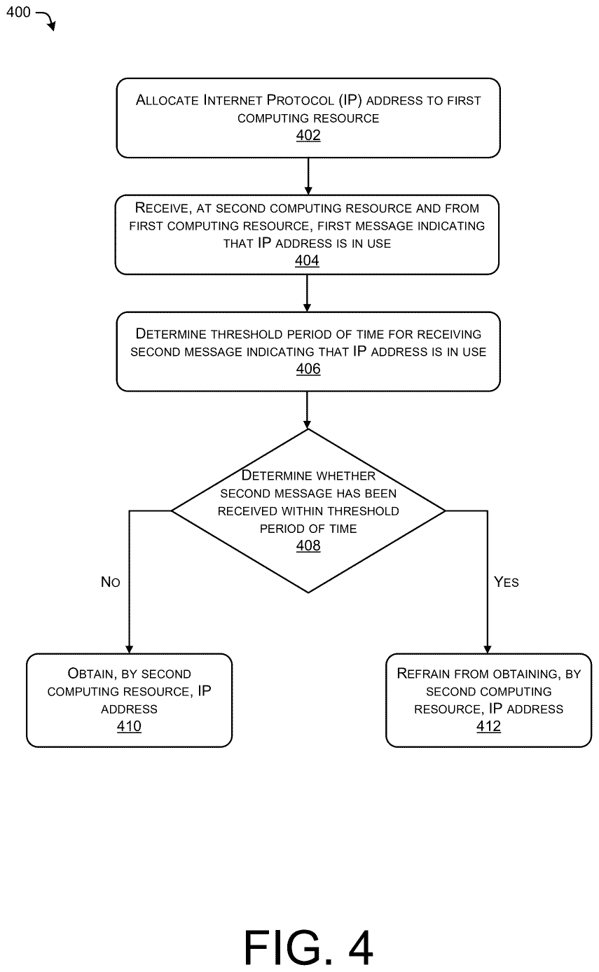

FIG. 4 illustrates a flow diagram of an example method 400 for IP address sharing. The techniques may be applied by a system comprising one or more processors, and one or more non-transitory computer-readable media storing computer-executable instructions that, when executed by the one or more processors, cause the one or more processors to perform operations of method 400.

The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, although the processes may be implemented in a wide variety of other environments, architectures and systems.

At block 402, the method 400 may include allocating an Internet Protocol (IP) address to a first computing resource. In some examples, a server system may comprise a server that may be associated with, or installed in, a network environment. The server system may be configured to receive an IP address from a Dynamic Host Configuration Protocol (DHCP) server. For example, the server system may receive the IP address from the DHCP server via the shared LOM Ethernet port connected to a network. In some instances, the management controller may include, or work in combination with, a DHCP client to request an IP address from the DHCP server via an interface of the shared LOM Ethernet port. Additionally, or alternatively, the management controller may receive the IP address from the DHCP server via a different type of port (e.g., dedicated management port, etc.). Additionally, or alternatively, the server system may be configured to be assigned a static IP address via an interface associated with the server system.

At block 404, the method 400 may include receiving, at a second computing resource and from the first computing resource, a first message indicating that the IP address is in use. In some instances, the server may be associated with a management controller that may be configured to remotely provide server management (e.g., across enterprise branch locations). For example, the management controller may be configured to manage and/or monitor the state of the server system independently of any associated processors or the server operating system. In some instances, the management controller may be configured to provide server management and/or monitoring remotely via an Intelligent Platform Management Interface (IPMI) running on the management controller.

Once the IP address has been allocated to the server system, such as to the management controller via a request by the DHCP client, the server may subsequently be started-up, booted, released from reset, etc. Additionally, or alternatively, the server may be configured to subsequently send a message to the management controller indicating that the IP address is in use, or will be in use, by the server. In some instances, the server may send the message via the IPMI. This way, the management controller may disable the DHCP client associated with the management controller and relinquish the IP address and/or disable the usage of the IP address. In some instances, once the IP address has been relinquished by the management controller, the server may receive, begin using, and/or continue using the IP address. For example, the server may receive the IP address from the DHCP server via the shared LOM Ethernet port and/or a different physical port. Accordingly, the server may subsequently use, and/or be associated with, the IP address for network communications. Additionally, or alternatively, the server may be configured to send additional messages to the management controller. The messages may include an indication that the IP address is being used by the server (i.e., an “IP alive” message) and/or an indication that the DHCP client associated with the management controller is to remain disabled. In some examples, the messages may be sent via the IPMI.

At block 406, the method 400 may include determining a threshold period of time for receiving a second message indicating that the IP address is in use. For example, the messages may be associated with a threshold period of time and/or time intervals for receipt by the management controller. For example, a message may be sent from the server to the management controller every two minutes. Additionally, or alternatively, the management controller may be configured to determine a threshold period of time at which the message is expected to be received (e.g., based on a message being sent every two minutes).

At block 408, the method 400 may include determining whether the second message has been received within the threshold period of time. For example, when a message is received and/or sent within the threshold period of time and/or the time intervals associated with the message, it may indicate that the server (e.g., processor, operating system, etc.) is functioning normally. When a message is not received and/or sent within the threshold period of time and/or the time intervals associated the message (e.g., five minutes have passed since a message has been received by the management controller), it may indicate that a failure has occurred with respect to the server.

At block 410, the method 400 may include, based at least in part on determining that the second message has not been received within the threshold period of time, obtaining, by the second computing resource, the IP address. For example, when a message is not received and/or sent within the threshold period of time and/or the time intervals associated the message, the management controller may be configured to reenable its use of the IP address. For example, in instances where the IP address was obtained via a DHCP server, the management controller may be configured to restart its associated DHCP client and receive the IP address. In instances where the IP address was obtained statically, the IP address may be stored locally at the management controller, and reenabled. Additionally, or alternatively, when the message is not received and/or sent within the threshold period of time and/or the time intervals associated the message, the management controller may be configured to enable the use of the IP address at a VM instance associated with the server, as opposed to reenabling the use of the IP address at the management controller.

At block 412, the method 400 may include, based at least in part on determining that the second message has been received within the threshold period of time, refraining from obtaining, by the second computing resource, the IP address. For example, when a message is received and/or sent within the threshold period of time and/or the time intervals associated with the message, it may indicate that the server (e.g., processor, operating system, etc.) is functioning normally.

Additionally, or alternatively, the method 400 may include receiving, at the second computing resource and from the first computing resource, a third message indicating that the IP address is in use, determining a threshold period of time for receiving a fourth message indicating that the IP address is in use, determining that the fourth message has not been received within the threshold period of time, and based at least in part on determining that the fourth message has not been received within the threshold period of time, obtaining, by the second computing resource, the IP address.

Additionally, or alternatively, the method 400 may include receiving, at the second computing resource and from the first computing resource, a third message indicating that the IP address is in use, determining a threshold period of time for receiving a fourth message indicating that the IP address is in use, determining that the fourth message has been received within the threshold period of time, and based at least in part on determining that the fourth message has been received within the threshold period of time, refraining from obtaining, by the second computing resource, the IP address.

Additionally, or alternatively, the method 400 may include based at least in part on the second computing resource obtaining the IP address, establishing a connection between the second computing resource and a remote entity, and receiving, at the second computing resource, a troubleshooting command to perform on the second computing resource.

Additionally, or alternatively, the method 400 may include wherein the second message not being received within the threshold period of time indicates at least one of a failure associated with the first computing resource and/or the first computing resource being unavailable.

Additionally, or alternatively, the method 400 may include wherein the second computing resource is a baseboard management controller (BMC).

Additionally, or alternatively, the method 400 may include wherein allocating the IP address to the first computing resource further comprises relinquishing, from the second computing resource and to a Dynamic Host Configuration Protocol (DHCP) server, the IP address such that the second computing resource is inaccessible.

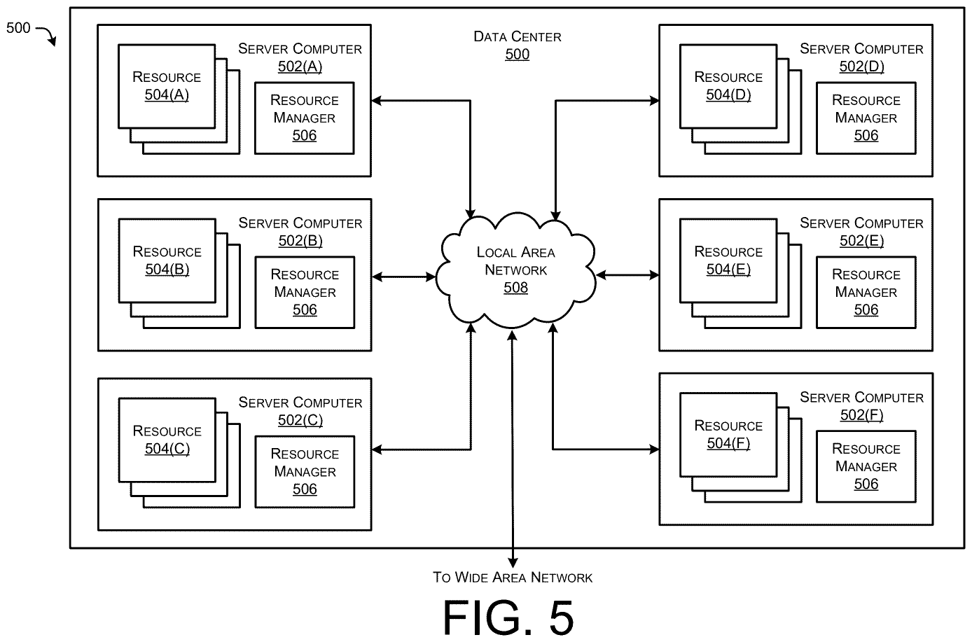

FIG. 5 is a computing system diagram illustrating a configuration for a data center 500 that can be utilized to implement aspects of the technologies disclosed herein. In one example, the data center 500 may be used to support a server system, such as server system 108. The example data center 500 shown in FIG. 5 includes several server computers 502A-502F (which might be referred to herein singularly as “a server computer 502” or in the plural as “the server computers 502”) for providing computing resources. In some examples, the resources and/or server computers 502 may include, or correspond to, the any type of networked device described herein. Although described as servers, the server computers 502 may comprise any type of networked device, such as servers, switches, routers, hubs, bridges, gateways, modems, repeaters, access points, etc.

The server computers 502 can be standard tower, rack-mount, or blade server computers configured appropriately for providing computing resources. In some examples, the server computers 502 may provide computing resources 504 including data processing resources such as VM instances or hardware computing systems, database clusters, computing clusters, storage clusters, data storage resources, database resources, networking resources, and others. Some of the server computers 502 can also be configured to execute a resource manager 506 capable of instantiating and/or managing the computing resources. In the case of VM instances, for example, the resource manager 506 can be a hypervisor or another type of program configured to enable the execution of multiple VM instances on a single server computer 502. Server computers 502 in the data center 500 can also be configured to provide network services and other types of services. In one example, server computers 502 may be used to support the server system 108 and/or the service provider network 106.

In the example data center 500 shown in FIG. 5, an appropriate LAN 508 is also utilized to interconnect the server computers 502A-502F. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 500, between each of the server computers 502A-502F in each data center 500, and, potentially, between computing resources in each of the server computers 502. It should be appreciated that the configuration of the data center 500 described with reference to FIG. 5 is merely illustrative and that other implementations can be utilized.

In some examples, the server computers 502 may each execute one or more application containers and/or virtual machines to perform techniques described herein.

In some instances, the data center 500 may provide computing resources, like application containers, VM instances, and storage, on a permanent or an as-needed basis. Among other types of functionality, the computing resources provided by a cloud computing network may be utilized to implement the various services and techniques described above. The computing resources 504 provided by the cloud computing network can include various types of computing resources, such as data processing resources like application containers and VM instances, data storage resources, networking resources, data communication resources, network services, and the like.

Each type of computing resource 504 provided by the cloud computing network can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing network can also be configured to provide other types of computing resources 504 not mentioned specifically herein.

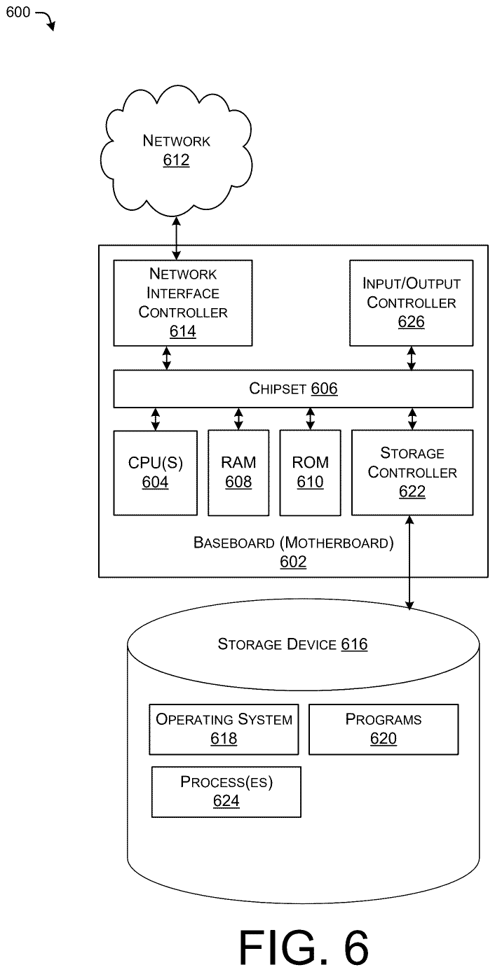

The computing resources 504 provided by a cloud computing network may be enabled in one embodiment by one or more data centers 500 (which might be referred to herein singularly as “a data center 500” or in the plural as “the data centers 500”). The data centers 500 are facilities utilized to house and operate computer systems and associated components. The data centers 500 typically include redundant and backup power, communications, cooling, and security systems. The data centers 500 can also be located in geographically disparate locations. One illustrative embodiment for a data center 500 that can be utilized to implement the technologies disclosed herein will be described below with regard to FIG. 6.

FIG. 6 shows an example computer architecture for a computer 600 capable of executing program components for implementing the functionality described above. The computer architecture shown in FIG. 6 illustrates a conventional server computer, workstation, desktop computer, laptop, tablet, network appliance, e-reader, smartphone, or other computing device, and can be utilized to execute any of the software components presented herein. The computer 600 may, in some examples, correspond to a network node described herein.

The computer 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a random-access memory (RAM) 608, used as the main memory in the computer 600. The chipset 606 can further provide an interface to a computer-readable storage medium such as a read-only memory (ROM) 610 or non-volatile RAM (NVRAM) for storing basic routines that help to startup the computer 600 and to transfer information between the various components and devices. The ROM 610 or NVRAM can also store other software components necessary for the operation of the computer 600 in accordance with the configurations described herein.

The computer 600 can operate in a networked environment using logical connections to remote computing devices and computer systems through a network, such as the network 612. The chipset 606 can include functionality for providing network connectivity through a network interface controller (NIC) 614, such as a gigabit Ethernet adapter. The NIC 614 is capable of connecting the computer 600 to other computing devices over the network 612. It should be appreciated that multiple NICs 614 can be present in the computer 600, connecting the computer 600 to other types of networks and remote computer systems. In some instances, the NICs 614 may include at least on ingress port and/or at least one egress port.

The computer 600 can be connected to a storage device 616 that provides non-volatile storage for the computer. The storage device 616 can store an operating system 618, programs 620, and data, which have been described in greater detail herein. The storage device 616 can be connected to the computer 600 through a storage controller 622 connected to the chipset 606. The storage device 616 can consist of one or more physical storage units. The storage controller 622 can interface with the physical storage units through a serial attached small computer system interface (SCSI) (SAS) interface, a serial advanced technology attachment (SATA) interface, a fiber channel (FC) interface, or other type of interface for physically connecting and transferring data between computers and physical storage units.

The computer 600 can store data on the storage device 616 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 616 is characterized as primary or secondary storage, and the like.

For example, the computer 600 can store information to the storage device 616 by issuing instructions through the storage controller 622 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 616 by detecting the physical states or characteristics of one or more particular locations within the physical storage units.

In addition to the mass storage device 616 described above, the computer 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 600. In some examples, the operations performed by any network node described herein may be supported by one or more devices similar to computer 600. Stated otherwise, some or all of the operations performed by a network node may be performed by one or more computer devices, such as computer 600, operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 616 can store an operating system 618 utilized to control the operation of the computer 600. According to one embodiment, the operating system comprises the LINUX™ operating system. According to another embodiment, the operating system includes the WINDOWS™ SERVER operating system from MICROSOFT Corporation of Redmond, Washington. According to further embodiments, the operating system can comprise the UNIX™ operating system or one of its variants. It should be appreciated that other operating systems can also be utilized. The storage device 616 can store other system or application programs and data utilized by the computer 600.

In one embodiment, the storage device 616 or other computer-readable storage media is encoded with computer-executable instructions which, when loaded into the computer 600, transform the computer from a general-purpose computing system into a special-purpose computer capable of implementing the embodiments described herein. These computer-executable instructions transform the computer 600 by specifying how the CPUs 604 transition between states, as described above. According to one embodiment, the computer 600 has access to computer-readable storage media storing computer-executable instructions which, when executed by the computer 600, perform the various processes described above with regard to FIGS. 1-5. The computer 600 can also include computer-readable storage media having instructions stored thereupon for performing any of the other computer-implemented operations described herein.

As illustrated in FIG. 6, the storage device 616 stores programs 620, which may include one or more processes 624, as well as any type of programs or processes to perform the techniques described in this disclosure for IP address sharing. That is, the computer 600 may comprise any one of the routers, load balancers, and/or servers. The programs 620 may comprise any type of program that cause the computer 600 to perform techniques for communicating with other devices using any type of protocol or standard usable for determining connectivity. The process(es) 624 may include instructions that, when executed by the CPU(s) 604, cause the computer 600 and/or the CPU(s) 604 to perform one or more operations.

The computer 600 can also include at least one input/output controller 626 for receiving and processing input from a number of input devices, such as a keyboard, a mouse, a touchpad, a touch screen, an electronic stylus, or other type of input device. Similarly, an input/output controller 626 can provide output to a display, such as a computer monitor, a flat-panel display, a digital projector, a printer, or other type of output device. It will be appreciated that the computer 600 might not include all of the components shown in FIG. 6, can include other components that are not explicitly shown in FIG. 6, or might utilize an architecture completely different than that shown in FIG. 6.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

As used herein, the term “based on” can be used synonymously with “based, at least in part, on” and “based at least partly on.” As used herein, the terms “comprises/comprising/comprised” and “includes/including/included,” and their equivalents, can be used interchangeably. An apparatus, system, or method that “comprises A, B, and C” includes A, B, and C, but also can include other components (e.g., D) as well. That is, the apparatus, system, or method is not limited to components A, B, and C.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
allocating an Internet Protocol (IP) address to a first computing resource;
receiving, at a second computing resource and from the first computing resource, a first message indicating that the IP address is in use;
determining a threshold period of time for receiving a second message indicating that the IP address is in use;
determining whether the second message has been received within the threshold period of time; and
based at least in part on determining that the second message has not been received within the threshold period of time, obtaining, by the second computing resource, the IP address; or
based at least in part on determining that the second message has been received within the threshold period of time, refraining from obtaining, by the second computing resource, the IP address.

2. The method of claim 1, the method further comprising:
receiving, at the second computing resource and from the first computing resource, a third message indicating that the IP address is in use;
determining a threshold period of time for receiving a fourth message indicating that the IP address is in use;
determining that the fourth message has not been received within the threshold period of time; and
based at least in part on determining that the fourth message has not been received within the threshold period of time, obtaining, by the second computing resource, the IP address.

3. The method of claim 1, the method further comprising:
receiving, at the second computing resource and from the first computing resource, a third message indicating that the IP address is in use;
determining a threshold period of time for receiving a fourth message indicating that the IP address is in use;
determining that the fourth message has been received within the threshold period of time; and
based at least in part on determining that the fourth message has been received within the threshold period of time, refraining from obtaining, by the second computing resource, the IP address.

4. The method of claim 1, the method further comprising:
based at least in part on the second computing resource obtaining the IP address, establishing a connection between the second computing resource and a remote entity; and
receiving, at the second computing resource, a troubleshooting command to perform on the second computing resource.

5. The method of claim 1, wherein the second message not being received within the threshold period of time indicates at least one of:
a failure associated with the first computing resource; or
the first computing resource being unavailable.

6. The method of claim 1, wherein the second computing resource is a baseboard management controller (BMC).

7. The method of claim 1, wherein allocating the IP address to the first computing resource further comprises relinquishing, from the second computing resource and to a Dynamic Host Configuration Protocol (DHCP) server, the IP address such that the second computing resource is inaccessible.

8. A system comprising:
one or more processors; and
one or more non-transitory computer-readable media storing computer-executable instructions that, when executed by the one or more processors, cause the one or more processors to perform operations comprising:
allocating an Internet Protocol (IP) address to a first computing resource;
receiving, at a second computing resource and from the first computing resource, a first message indicating that the IP address is in use;
determining a threshold period of time for receiving a second message indicating that the IP address is in use;
determining that the second message has not been received within the threshold period of time; and
based at least in part on determining that the second message has not been received within the threshold period of time, obtaining, by the second computing resource, the IP address.

9. The system of claim 8, the operations further comprising:
receiving, at the second computing resource and from the first computing resource, a third message indicating that the IP address is in use;
determining a threshold period of time for receiving a fourth message indicating that the IP address is in use;
determining that the fourth message has been received within the threshold period of time; and
refraining from obtaining, by the second computing resource, the IP address.

10. The system of claim 8, the operations further comprising:
based at least in part on the second computing resource obtaining the IP address, establishing a connection between the second computing resource and a remote entity; and
receiving, at the second computing resource, a troubleshooting command to perform on the second computing resource.

11. The system of claim 8, wherein the second message not being received within the threshold period of time indicates at least one of:
a failure associated with the first computing resource; or
the first computing resource being unavailable.

12. The system of claim 8, wherein the second computing resource obtaining the IP address further comprises enabling the use of the IP address by a virtual machine (VM) instance associated with the first computing resource.

13. The system of claim 8, wherein allocating the IP address to the first computing resource further comprises relinquishing, from the second computing resource and to a Dynamic Host Configuration Protocol (DHCP) server, the IP address such that the second computing resource is inaccessible.

14. One or more non-transitory computer-readable media storing computer-executable instructions that, when executed by one or more processors, cause the one or more processors to perform operations comprising:
allocating an Internet Protocol (IP) address to a first computing resource;
receiving, at a second computing resource and from the first computing resource, a first message indicating that the IP address is in use;
determining a threshold period of time for receiving a second message indicating that the IP address is in use;
determining that the second message has not been received within the threshold period of time; and
based at least in part on determining that the second message has not been received within the threshold period of time, obtaining, by the second computing resource, the IP address.

15. The one or more non-transitory computer-readable media of claim 14, the operations further comprising:
receiving, at the second computing resource and from the first computing resource, a third message indicating that the IP address is in use;
determining a threshold period of time for receiving a fourth message indicating that the IP address is in use;
determining that the fourth message has been received within the threshold period of time; and
refraining from obtaining, by the second computing resource, the IP address.

16. The one or more non-transitory computer-readable media of claim 14, the operations further comprising:
based at least in part on the second computing resource obtaining the IP address, establishing a connection between the second computing resource and a remote entity; and
receiving, at the second computing resource, a troubleshooting command to perform on the second computing resource.

17. The one or more non-transitory computer-readable media of claim 14, wherein the second message not being received within the threshold period of time indicates at least one of:
a failure associated with the first computing resource; or
the first computing resource being unavailable.

18. The one or more non-transitory computer-readable media of claim 14, wherein the second computing resource obtaining the IP address further comprises enabling the use of the IP address by a virtual machine (VM) instance associated with the first computing resource.

19. The one or more non-transitory computer-readable media of claim 14, wherein allocating the IP address to the first computing resource further comprises relinquishing, from the second computing resource and to a Dynamic Host Configuration Protocol (DHCP) server, the IP address such that the second computing resource is inaccessible.

20. The one or more non-transitory computer-readable media of claim 14, wherein the IP address is a static IP address, and allocating the IP address to the first computing resource further comprises relinquishing, from the second computing resource, the IP address such that the second computing resource is inaccessible, and an indication of the IP address is stored at the second computing resource.
